(19) United States
(12) Patent Application Publication
(10) Pub. No.: US 2006/0071130 A1
(43) Pub. Date: Apr. 6, 2006

(54) Unmanned, vandal-resistant, self-contained, tower-based, wireless, solar-powered surveillance unit and system

(75) Inventors: Bruce Dell Kopitar, Visalia, CA (US); Nick Anthony Giotta, Visalia, CA (US)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Wireless Eye, Inc., Visalia, CA (US)

(21) Appl. No.: 11/228,736

(22) Filed: Sep. 16, 2005

Related U.S. Application Data
(60) Provisional application No. 60/610,675, filed on Sep. 17, 2004.

(51) Int. Cl. F16M 11/00; H04B 1/03; G08B 23/00

(52) U.S. Cl. 248/157; 361/815; 340/693.9

(57) ABSTRACT

A self-contained surveillance unit includes a climb-resistant tower and a heavy, but portable, base supporting the tower. The tower has various components affixed thereto. All components sufficient for operation of the surveillance unit, including observation, wireless-communication and self-powering components, are located on the tower well above the ground at a height sufficient to render them difficult to access from the ground. At least one such self-contained surveillance unit may form part of a surveillance communications network in which the network also has one or more central transmitting and receiving sites having monitoring facilities.

This application claims the benefit of U.S. Provisional Patent Application Ser. No. 60/610,675 filed Sep. 17, 2004 entitled “Unmanned, Vandal-Resistant, Self-Contained, Tower-Based, Wireless, Solar-Powered Surveillance Unit and System,” and it is hereby incorporated by reference in its entirety.

### FIELD OF THE INVENTION

The invention relates to surveillance systems. More specifically, the invention relates to an unmanned, vandal-resistant, self-contained, tower-based, wireless, solar-powered surveillance unit, in which the tower is supported by a heavy but preferably portable base. The invention also relates to a local network that may include one or more of such tower-based surveillance units. The invention also relates to a wide area network, such as the Internet, that may include one or more of such local networks.

### BACKGROUND OF THE INVENTION

Unmanned surveillance systems for monitoring sites remote from a monitoring location are well known. Tower-based systems are disclosed, for example, in U.S. Pat. Nos. 6,375,370; 6,585,428; 6,709,171; and 6,709,172. Each of said patents are hereby incorporated by reference in its entirety. The surveillance systems disclosed in said four patents employ a tower support base having a hollow enclosure that houses various equipment related to the operation of the surveillance system. In order to enhance the vandalism resistance of a tower-based surveillance system, it would be desirable to locate all components of the surveillance system on the tower at a height sufficient to render them difficult to access rather than locating at least some of them at ground level. It would also be desirable to provide a tower-based surveillance system that is totally self-contained (e.g., wireless and solar powered) in order further to enhance vandalism resistance.

### SUMMARY OF THE INVENTION

Aspects of the present invention include an improved unmanned tower-based surveillance unit for monitoring sites remote from a monitoring location, such units being self-contained, solar-powered, and wireless. All components relating to operation of the surveillance unit are located on the tower at a height sufficient to render them difficult to access from the ground. Each unit may be part of a local network of one or more surveillance units that communicate wirelessly with one or more central transmitting and receiving sites, each of which may include monitoring facilities. The local network may be part of a wide-area network, such as the Internet, for example, in order to allow monitoring access, for example, at locations other than at central sites such as at the home or business of a client of an organization that provides remote surveillance monitoring. Such access may employ well-known Internet Transmission Control Protocol/Internet Protocol (TCP/IP) techniques. The assignee of the present invention has adopted the trademarks “Wireless Surveillance over IP” and “WSoIP” for such surveillance monitoring.

### BRIEF DESCRIPTION OF THE DRAWINGS

FIG. 1 is a perspective view of an exemplary embodiment of a tower and base having components affixed thereto that together provide a wireless, solar-powered surveillance unit in accordance with aspects of the present invention.

FIG. 2 is a close-up perspective view of the tower base of the surveillance unit embodiment of FIG. 1.

FIG. 3 is close-up perspective view of a portion of the surveillance unit embodiment of FIG. 1, showing solar panels and an enclosure for related equipment in greater detail.

FIG. 4 is a close-up perspective view of the solar panels and enclosure of FIG. 3 from a different vantage point from which the underside of the solar panels is seen.

FIG. 5 is a close-up perspective view of a portion of the surveillance unit embodiment of FIG. 1, showing antennas, a camera housing, and an enclosure for related equipment in greater detail.

FIG. 6 is a conceptual schematic diagram showing a local network and wide-area network, such as the Internet, in which a wireless, solar-powered surveillance unit in accordance with aspects of the present invention may be advantageously employed.

### DETAILED DESCRIPTION OF THE PREFERRED EMBODIMENTS

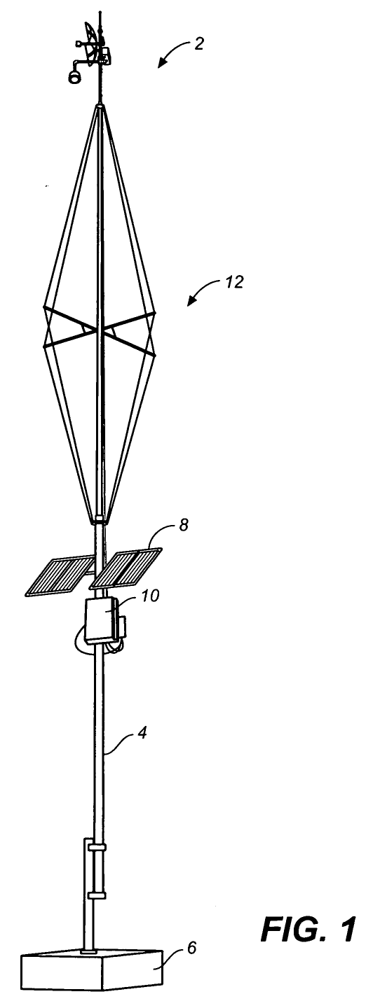

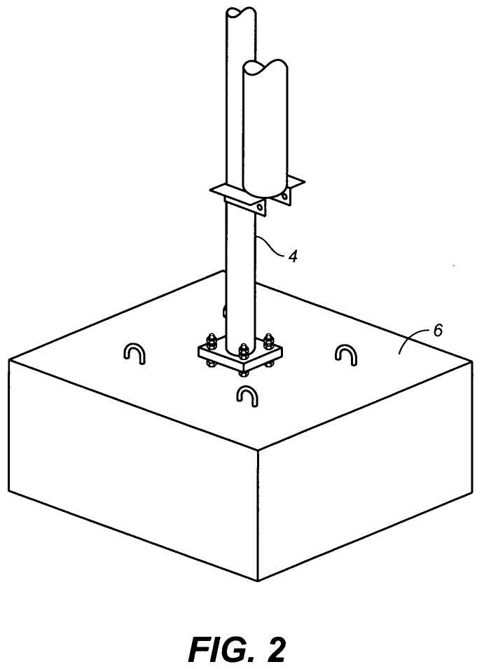

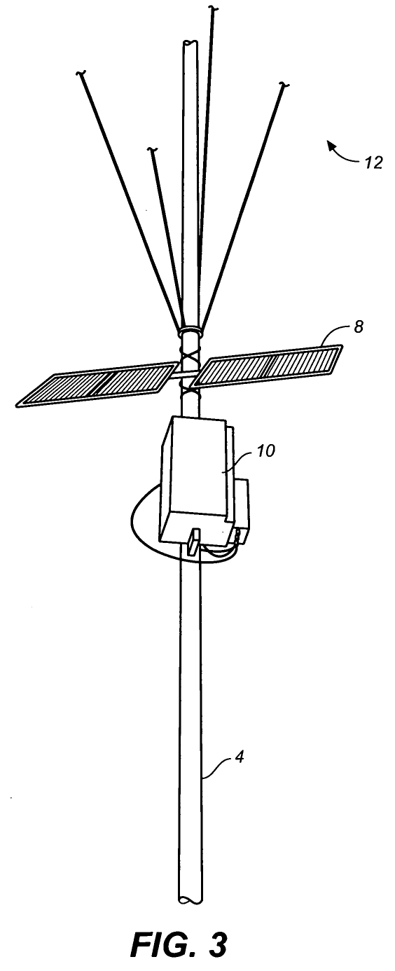

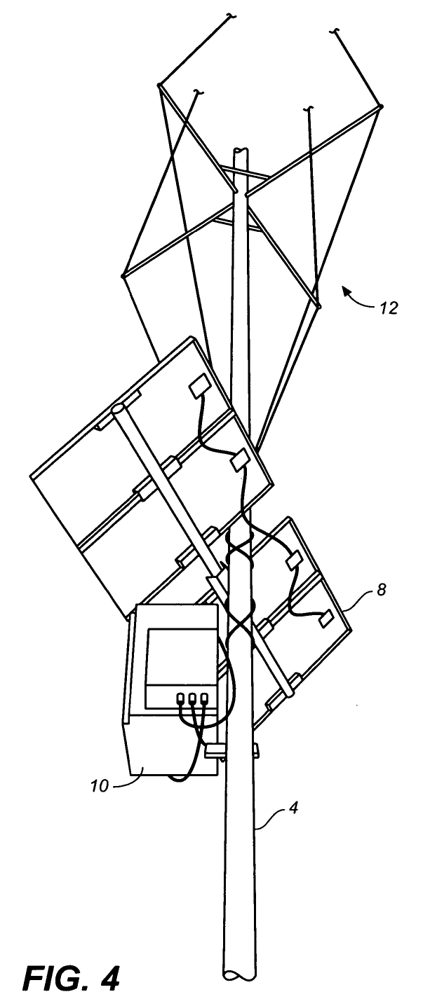

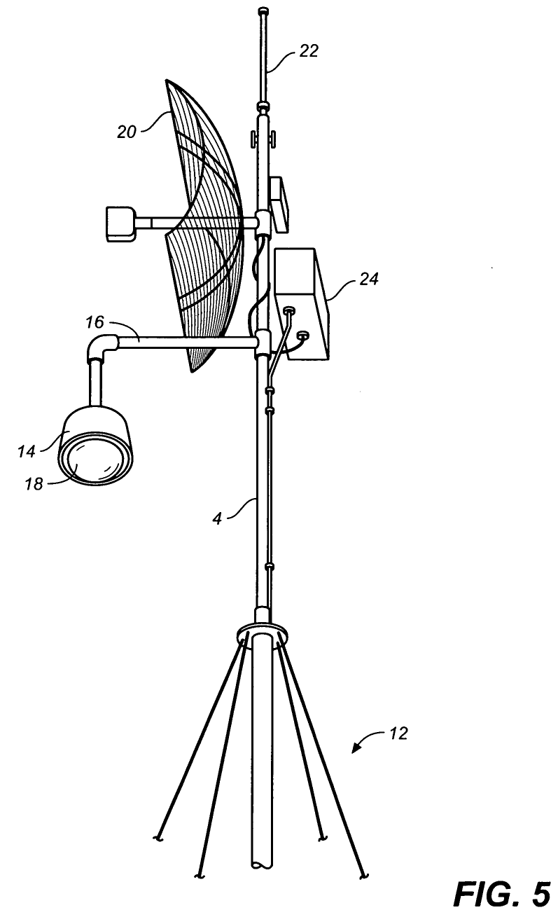

An embodiment of a tower-based surveillance unit 2 that includes various aspects of the present invention will now be described in connection with FIGS. 1 through 5. A telescoping tubular tower 4 is supported by a heavy concrete base 6. Although a telescoping tubular tower configuration provides a convenient support for components of the surveillance unit, it is not critical to the invention and other tower configurations may be employed. Alternative tower configurations include, for example, a fixed tubular tower, a telescoping lattice tower, and a fixed lattice tower. If a telescoping or fixed lattice tower is employed, they should employ appropriate coverings to discourage climbing. The heavy tower base may be a non-penetrating (i.e., it does not penetrate the earth) concrete base, for example, having a weight sufficient to support the tower attached to it, while permitting transportation by suitable heavy equipment but which discourages vandalism. Although a 9,000 pound base has been found to be suitable, the weight is not critical and much lighter weights may be usable provided that they cannot be readily moved manually and provide sufficient support for the tower. For some applications, a mobile trailer mounted tower may be acceptable. The tower height is not critical, provided that it is sufficient to allow the various surveillance unit components to be mounted so as to render them difficult to access from the ground and to place the surveillance unit's observation component(s) sufficiently high to observe the site. In the example shown in the figures, the tower height is 70 feet. In practice, a tower height of at least 15 or 20 feet may be required to assure that the lowest components are not reachable from the ground. A tower height of as much as 100 feet may be usable. Although a tilt-over telescoping tubular tower is shown in the figures (see particularly FIGS. 1 and 2), this is not critical to the invention and the tower need not be so configured.

Components mounted on the tower include a set of solar panels 8 and an enclosure 10 for equipment associated with the solar panels. Such equipment in enclosure 10 may include, for example, one or more batteries and circuits for regulating the charging of such batteries by the solar panels. Such arrangements are well known. The equipment may also include, for example, voltage regulators and circuit breakers useful in providing power from the batteries to other components mounted on the tower. Such arrangements for providing power from solar-charged batteries are also well known. Enclosure 10 should be water-tight to protect the equipment contained within it (while providing appropriate venting for cooling, if necessary). Various cables are shown connecting the solar panels to the enclosure and connecting the enclosure to components located higher on the tower. It will be noted that the enclosure 10 is located well above the ground, about twenty feet in this example, and that no cables run downward from the enclosure. Due to their large windload, it is desirable to locate the solar panels below other components on the tower.

A self-guying arrangement 12 that includes a pair of cross arms is located above the solar panels 8 in order to stiffen the tubular tower and increase its height and wind-load capability. Such a self-guying arrangement is not a necessary aspect of the present invention.

At and near the top of the tower 4 and above the self-guying arrangement 12, observation, radio communication, and, optionally, control components are mounted. In this example, a downward-viewing video camera is located within an enclosure 14 supported by an outward- and downward-extending arm 16. The enclosure 14 includes a transparent cover 18 through which the camera may view the site. The transparent cover and camera enclosure may be impact resistant. Although only one camera support and housing is shown, multiple observation components may be employed. Although this example employs a video camera, such as a high-resolution video camera of the type used for wired CCTV applications, other types of observation components may be employed instead of or in addition to a video camera—for example, a still camera, a microphone, a motion detector, and/or lights. Two antennas are shown, a directional antenna 20 and an omni-directional antenna 22. Various antennas and antenna configurations may be employed depending on the communications requirements. Electronics, including one or more transmitters or transceivers associated with the video camera and antennas are housed in an enclosure 24. Various cables are shown connecting the video camera and the antennas to the enclosure. Arrangements for operating transmitters or transceivers with observation devices and associated antennas are well known. In addition to transmitting information from the observation devices, a transceiver may permit instructions to be received in order to control the one or more observation devices (e.g., to power them on and off, to control their direction, etc.). Enclosure 24 should be water-tight to protect the equipment contained within it (while providing appropriate venting for cooling, if necessary).

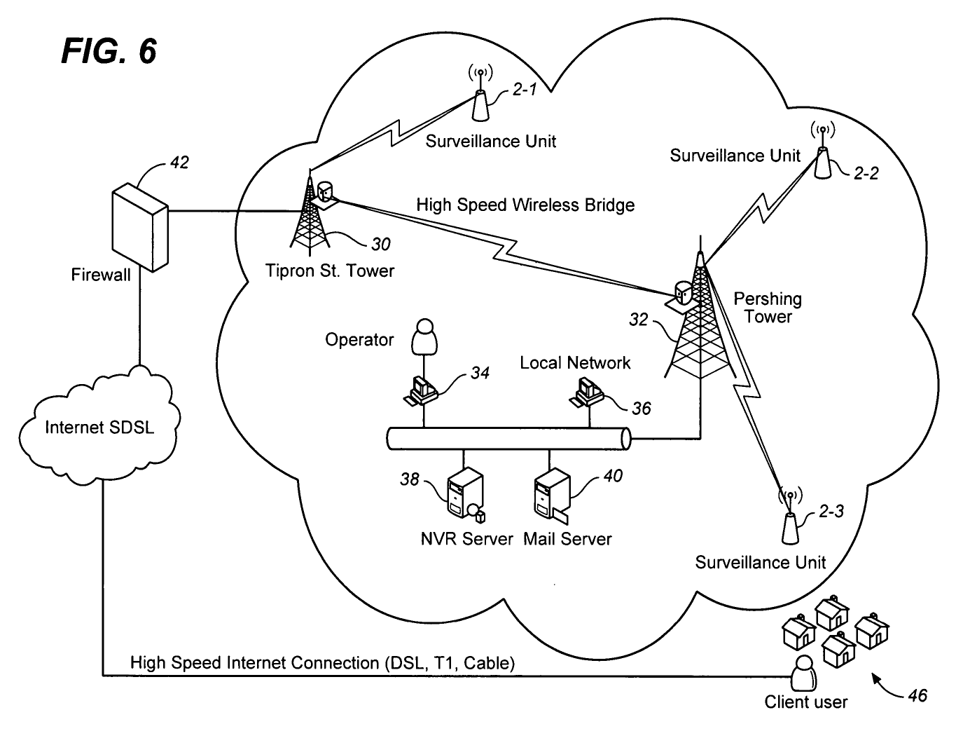

One possible network surveillance arrangement is shown in FIG. 6. A first surveillance unit 2-1 is shown in communication with a central receiving (or receiving and transmitting) site 30. Second and third surveillance units 2-2 and 2-3, respectively, are shown in communication with a central receiving (or receiving and transmitting) site 32. Maximum distances from a remote unit to a central site may be about fifteen miles, depending on terrain, antenna gain, frequency, and transmitter power. The central sites 30 and 32 are shown in communication with one another via a high speed wireless bridge. Each central site may have its own monitoring facility that includes, for example, one or more computers with monitors (34 and 36) for use by human operators, an NVR (Networked Video Recording) server 38 and a mail server 40. The NVR server may operate in conjunction with one or more suitable video recording devices, for example, for recording video images received from remote surveillance units. Such arrangements are well known in closed circuit television (CCTV) surveillance systems. In addition to receiving observation information, such as video images, from the remote surveillance units, the central sites may also send information or instructions to ones of the remote surveillance units either automatically or under the control of one or more human operators. Such outward transmissions may, for example, turn various observation units on or off or may change their direction of observation. One of the central sites 30 is shown connected via a firewall 42, a symmetrical DSL modem 44, and a high speed Internet connection (DSL, T1, cable, etc.) to the Internet. Using TCP/IP technology, the remote observation information may then be available to one or more client users 46. As noted above, the assignee of the present invention has adopted the trademarks “Wireless Surveillance over IP” and “WSoIP” for such surveillance monitoring.

We claim:

1. A self-contained surveillance unit, comprising
a climb-resistant tower,
a heavy, but portable, base supporting the tower,
the tower having various components affixed thereto, wherein all components sufficient for operation of the surveillance unit, including observation, wireless-communication and self-powering components, are located on the tower well above the ground at a height sufficient to render them difficult to access from the ground.

2. A self-contained surveillance unit according to claim 1 wherein the base does not penetrate the ground.

3. A self-contained surveillance unit according to claim 1 wherein the weight of the base is transportable by suitable heavy equipment but is sufficiently heavy to discourage manual movement.

4. A self-contained surveillance unit according to claim 1 wherein the base is a mobile trailer.

5. A self-contained surveillance unit according to claim 1 wherein the tower is a telescoping tubular tower.

6. A self-contained surveillance unit according to claim 5 wherein the tower is a tilt-over telescoping tubular tower.

7. A self-contained surveillance unit according to claim 1 wherein the tower is a lattice tower having coverings to discourage climbing.

8. A self-contained surveillance unit according to claim 7 wherein the tower is a telescoping lattice tower.

9. A self-contained surveillance unit according to claim 1 wherein the self-powering components include solar power components.

10. A self-contained surveillance unit according to claim 1 wherein the observation components include one or more video cameras, still cameras, microphones, motion detectors, and lights.

11. A self-contained surveillance unit according to claim 1 wherein the wireless communication components communicate wirelessly with one or more transmitting and receiving sites that include monitoring facilities.

12. A self-contained surveillance unit according to claim 1 wherein the wireless communication components include a transmitter for sending observation information.

13. A self-contained surveillance unit according to claim 12 wherein the wireless communication components include a receiver for receiving information for controlling one or more observation components.

14. A self-contained surveillance unit according to claim 1 wherein:
the self-powering components include solar power components,
the observation components include one or more video cameras, still cameras, microphones, motion detectors, and lights, and
the wireless communication components communicate wirelessly with one or more transmitting and receiving sites that include monitoring facilities.

15. A self-contained surveillance unit according to claim 1 wherein:
the self-powering components include solar power components,
the observation components include one or more video cameras, still cameras, microphones, motion detectors, and lights, and
the wireless communication components include a transmitter for sending observation information.

16. A self-contained surveillance unit according to claim 1 wherein:
the self-powering components include solar power components,
the observation components include one or more video cameras, still cameras, microphones, motion detectors, and lights, and
the wireless communication components include a transmitter for sending observation information and a receiver for receiving information for controlling one or more observation components.

17. A surveillance communications network, comprising
one or more surveillance units, and
one or more central transmitting and receiving sites having monitoring facilities, wherein at least one surveillance unit is a self-contained surveillance unit in accordance with claim 1.

18. A surveillance communications network in accordance with claim 17 in which the network is local network that is a part of wide-area network, the Internet, whereby monitoring access is available at locations other than said one or more central transmitting and receiving sites.

19. A surveillance communications network in accordance with claim 17 in which at least one central site includes one or more of:
computers with monitors for use by human operators, and
a device for recording video images from surveillance units.

20. A surveillance communications network in accordance with claim 17 in which at least one central site sends information or instructions to ones of the remote surveillance units either automatically or under the control of one or more human operators.

21. A surveillance communications network in accordance with claim 20 in which the information or instructions turn various observation components on or off or change their direction of observation.
